(19) United States
(12) Patent Application Publication
(10) Pub. No.: US 2013/0256488 A1
(43) Pub. Date: Oct. 3, 2013

(54) Hook microphone holder

(71) Applicants: Sean Mahoney, Manteca, CA (US); Jeff Traser, Manteca, CA (US)

(72) Inventors: Sean Mahoney, Manteca, CA (US); Jeff Traser, Manteca, CA (US)

(21) Appl. No.: 13/506,188

(22) Filed: Apr. 3, 2012

(51) Int. Cl. H04R 1/02

(52) U.S. Cl. 248/286.1

(57) ABSTRACT

The present invention is a holder for microphones used for stage and studio performances. The present invention provides flexible angle and distance adjustments allowing the microphone to be positioned close to sound producing devices. The present invention allows the user to take advantage of the geometry of equipment used in stage and studio production to position the microphone in the most advantages ways.

### BACKGROUND OF THE INVENTION

1. Field of the Invention:

This invention relates to a method for holding microphones associated with stage and studio productions.

2. Description of the Prior Art:

Methods for holding microphones for stage productions include stands like U.S. Pat. No. 6,663,060 which teaches MICROPHONE STAND published by Robert Wayne Gifford, Sr., on Dec. 16, 2003. Microphone stands like MICROPHONE STAND'S of U.S. Pat. No. 6,663,060 are sized to meet the height of people who perform, and are not suitable for mounting microphones by other sources of sound. The MICROPHONE STAND is heavy and long. It is too cumbersome for the needs of all sound microphone placement needs.

United States Patent Application 20030123689 published by Satoshi Uchimura and Osamu Kono on Jul. 3, 2003 which teaches MICROPHONE HOLDER is small and able to be placed near other sources of sound than people performing, but it is designed has to be drawn into cloth that it is held to. The cloth is not usually down where the sound is. The MICROPHONE HOLDER is not versatile enough to meet the needs of all stage equipment geometries.

### SUMMARY OF THE INVENTION

THE HOOK MICROPHONE HOLDER fits into equipment on the stage allowing the microphone to be situated close to the source of sound emanating from devices or other sources. THE HOOK MICROPHONE HOLDER is designed with a arching hook shaped base unit that that fits under handles of equipment such as an electric guitar amplifier, or it fits between and amp head and speaker cabinet, or it slides under a speaker cabinet or combo amplifier that will stack on the base unit holding THE HOOK MICROPHONE HOLDER in place.

THE HOOK MICROPHONE HOLDER features an adjustment tee knob that allows the relationship between the hook shaped base unit to be fixed by tightening. Both the angle between the base unit and the distance the microphone is held can be adjusted using, the tee knob. The tee knob on the inside is female threaded onto a bolt that holds the base stationary piece and the boom clamp together. The operation of the tee knob, bolt, base stationary piece, and the boom swivel together give THE HOOK MICROPHONE HOLDER the unique versatility that distinguishes it from all others. THE HOOK MICROPHONE HOLDER is compact, versatile, and allows the microphone to be accurately placed. THE HOOK MICROPHONE HOLDER is not as tall as a person as Robert Gifford's MICROPHONE STAND, nor is it restricted to fastening to cloth as Satoshi Uchimura's MICROPHONE HOLDER is.

THE HOOK MICROPHONE HOLDER features a hex nut at the end of the boom that insures that the boom does not slip out of the boom swivel clamp. At the opposite end of the boom from the hex nut is the threaded microphone adaptor where the microphone can be attached.

### BRIEF DESCRIPTION OF THE DRAWINGS

FIG. 1 is a view of THE HOOK MICROPHONE HOLDER as it would be seen if it were holding a microphone below its base.

FIG. 2 is an expanded view of the Twist Grip Adaptor.

FIG. 3 is a view of THE HOOK MICROPHONE HOLDER in use on a piece of stage equipment.

### BEST MODE FOR CARRYING OUT THE INVENTION

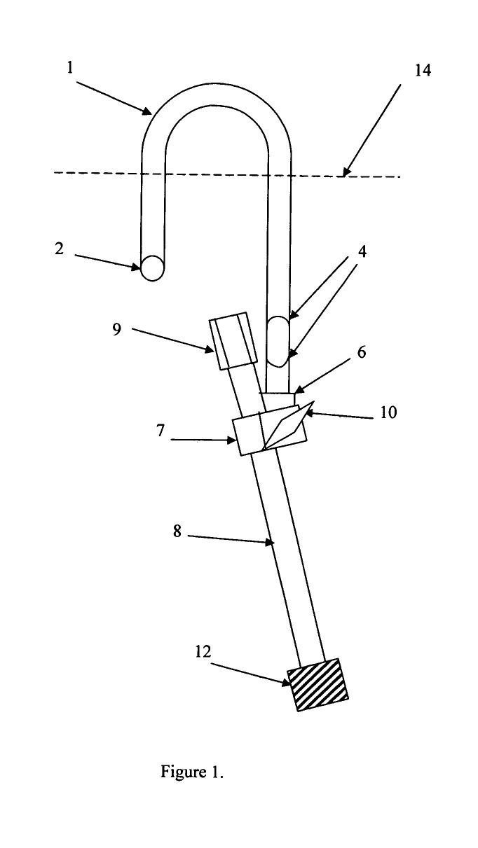

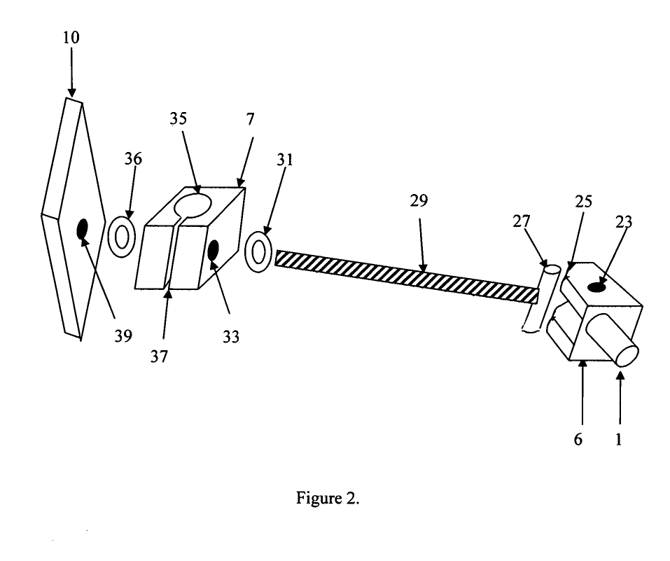

This description of the invention will be referring to the two drawings provided in FIGS. 1 and 2. In FIG. 1, the part of THE HOOK MICROPHONE HOLDER numbered 1 is the base. The base 1 may be covered with a thick layer of rubberized material to make it easily gripped by the handle or grip of equipment that it can be slipped in to. The base unit 1 can be pushed under the handle that a person can lift a piece of equipment with to carry it like a suit case. With the base unit 1 thus lodged in the handle of the equipment the microphone will be securely held by THE HOOK MICROPHONE HOLDER.

The base unit 1 covered with a thick rubberized material also protects the surface of equipment that the base unit 1 will be placed under to secure the microphone position. Dotted line 14 is illustrates there the base unit 1 may be place under a handle or the edge of a piece of equipment. The curved part of THE HOOK MICROPHONE HOLDER will be under the piece of equipment or under the equipment handle. The end of the base unit 1 is stopped using an end cap 2 that keeps moisture and dust out of the inside of the base unit 1 which may be made of a tubular material in order to be light weight. In an alternative embodiment the base unit 1 which is a drawn as a hook shape can be a paddle or a “Y” shape. The base unit 1 maybe composed of other material than metal tube. The material may be wood or plastic to suit different decorative requirements.

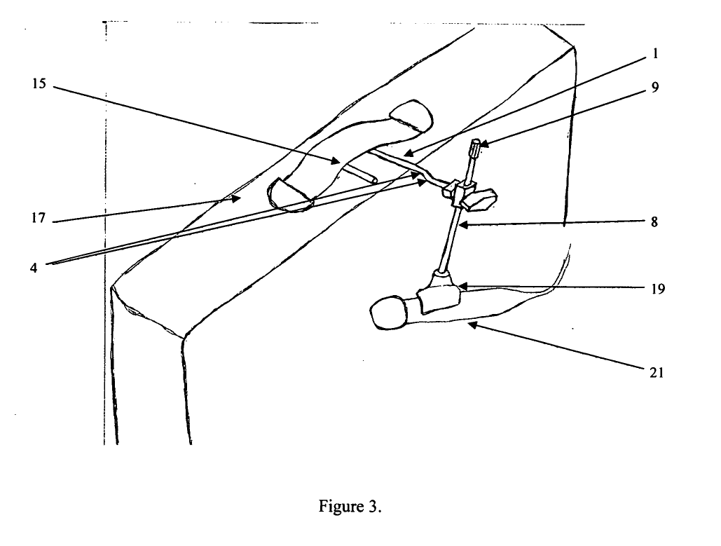

In FIG. 1, it will be noticed that the bends in base unit 1 are indicated by curved lines labeled 4. These two bends 4 are evident in FIG. 3. These bends aid in placement of the boom 8 in particular stage geometries. It is seen that base unit 1 terminates into base stationary piece 6. The base stationary piece 6 is the firm connecting part of base unit 1 that the boom swivel clamp 7 clamps to. The clamping holds boom 8 in a particular position for setting the microphone precisely where it must be positioned. Tee knob 10 is a female nut that tightens on bolt 29 that is seen in FIG. 2.

The desired tightening is accomplished by twisting tee knob 10. When tee knob 10 is tightened sufficiently on bolt 29 the position of boom 8 is fixed. The combination of base stationary piece 6, boom swivel clamp 7, bolt 29, and tee knob 10 are termed the Twist Grip Adaptor. Boom 8 is terminated on one end by microphone adaptor 12 and on the other by hex nut 9. Microphone adaptor 12 is threaded to screw into the threaded hole on a microphone holder. Hex nut 9 terminates boom 8 so that when tee knob 10 is loose boom 8 does not slide out of boom swivel clamp 7.

FIG. 2 is an expanded view of Twist Grip Adaptor. The bolt 29 has a cylindrical end 27 that is fitted into through hole 23 in base stationary piece 6. The cylindrical end of bolt 6 allows bolt 6 to rotate thought slightly more than 90 degrees. The FIG. 2 shows base unit 1 cut off for convenience of drawing on one page. It will be noticed that base stationary piece 6 has a quarter round corner 25 that inside washer 31 slides on allowing various angles between base unit 1 and bolt 29. Details of boom swivel clamp 7 are seen in FIG. 2. Clamp through hole 33 allows bolt 29 to pass through to be connected to tee knob 10. When tee knob 10 is tightened on to bolt 29 the clamp gap 37 can be made to close and boom hole 35 is made to clap on boom 8 that passes through clamp through hole 33. When boom 8 is clamped in boom hole 35 the position and angle of the end of boom 8 is fixed. Outer washer 36 allows sure repeated clamping of tee knob 10 on bolt 29. Female threaded hole 39 threaded on to bolt 29 to allow tightening of the twist grip adaptor fixing angle and distance of boom 8.

FIG. 3 is a view of THE HOOK MICROPHONE HOLDER in use on example stage equipment 17. THE HOOK MICROPHONE HOLDER is under the handle 15 of the example stage equipment 17. THE HOOK MICROPHONE HOLDER is manufactured of tubular metal for light weight strong construction, but can be fabricated from other materials or coated with other materials for decorative effects.

THE HOOK MICROPHONE HOLDER is attached to the microphone holder 19 that has a microphone 21 in it as is pictured in FIG. 3.

What I claim as my invention is:

1. A microphone holder comprised of a base unit, a base unit stationary piece with a quarter round curved surface for positioning the angle of clamping, a boom, a boom swivel clamp, a male threaded bolt, a hex nut, and a female threaded tee knob which allows a boom that the microphone is connected to, to be fastened in position by tightening the tee knob on the bolt allowing both angle on the quarter round surface and the angle of the boom in the boom swivel clamp and the angle of the bolt and distance to be adjusted to position the microphone to collect sound most effectively.

2. A microphone holder as is claimed in claim 1 that allows the base unit to be held under a handle of stage equipment allowing angular adjustment of the microphone position in the plane of the perpendicular to the boom and angular adjustment in the plane perpendicular to the bolt and angular adjustment around the quarter round surface of the base unit relative to the handle of stage equipment.

3. A microphone holder as is claimed in claim 1 that allows the base unit to be held under the body of stage equipment allowing angular adjustment of the microphone position in the plane of the perpendicular to the boom and angular adjustment in the plane perpendicular to the bolt and angular adjustment around the quarter round surface of the base unit relative to the body of stage equipment.

4. A microphone holder as is claimed in claim 1 where the base unit is a hooking piece of metal on one end and a quarter round surface for fastening with different angular orientations on the other.

5. A microphone holder as is claimed in claim 1 where the base unit is a paddle shape extending away from the quarter round adjusting surface on the other end of the base unit.

6. A microphone holder as is claimed in claim 1 where the base unit is a Y shape extending away from the quarter round adjusting surface on the other end of the base unit.

7. A microphone holder as is claimed in claim 1 where the base unit is covered with a thick layer of rubberized material allowing firm gripping of the base unit extending away from the quarter round adjusting surface.

8. A twist grip adaptor comprised of a boom swivel clamp, a bolt, a base stationary piece with a quarter round curved surface for positioning the angle of clamping, and a tee knob that allows a boom to be fastened into position in angle and distance by tightening said tee knob on said bolt.

9. (canceled)

10. (canceled)

11. A method of holding a microphone in an advantageous position comprised of a boom that is adjustable in angle and length from a boom swivel clamp adapter attached to a base unit that is held by given equipment being accomplished in the following steps:
the microphone is affixed to the threaded end of the boom
the base unit is placed under equipment near the sound source
the base unit is alternatively placed under the handle of the equipment near the sound source
the angle and length of the boom extending from the stationary piece are adjusted to the desired position taking advantage of the flexibility afforded by the twist grip adaptor
the tee knob is tightened to bring the bolt to draw the boom swivel clamp to tighten onto the curved surface of the corner of the base stationary piece
securing the microphone in the desired position preserving the angle on the quarter round surface and the angle of the boom in the boom swivel clamp and the angle of the bolt and distance chosen.

12. A method for holding a microphone as is claimed in claim 11 that allows the base unit to be held under the handle of stage equipment.

13. A method for holding a microphone as is claimed in claim 11 that allows the base unit to be held under the body of stage equipment.

14. A method for holding a microphone as is claimed in claim 11 that allows for the style of the base unit to be a hooked piece of metal.

15. A method for holding a microphone as is claimed in claim 11 that allows for the style of the base unit to be one covered with a layer of rubberized material.

16. A method for holding a microphone as is claimed in claim 11 that allows for the style of the base unit to be paddle shaped.

17. A method for holding a microphone as is claimed in claim 11 that allows for the style of the base unit to have a Y shape.

18. A method for holding a microphone as is claimed in claim 11 that allows three axes of rotational adjustment and length adjustment along the boom at the same time with one tightening of the tee knob for optimal placement of the microphone.

19. A microphone holder as is claimed in claim 1 that allows three axis of rotational adjustment and length adjustment along the boom at the same time with one tightening of the tee knob for optimal placement of the microphone.

20. A twist grip adaptor as is claimed in claim 8 that allows angular adjustment out from the quarter round surface and simultaneously in the plane perpendicular to the bolt and simultaneously the boom can be fastened at various lengths and at various angles in the plane perpendicular to the boom.
